(19) United States
(12) Patent Application Publication
(10) Pub. No.: US 2005/0249550 A1
(43) Pub. Date: Nov. 10, 2005

(54) Connector apparatus for conversion between a long handle and a short handle

(75) Inventor: Jou Guo Liang, Taichung (TW)

Correspondence Address: TROXELL LAW OFFICE PLLC;SUITE 1404, 5205 LEESBURG PIKE, FALLS CHURCH, VA, 22041, US

(73) Assignee: Inn Chuang Industrial CO., LTD.

(21) Appl. No.: 10/838,356

(22) Filed: May 5, 2004

(51) Int. Cl. F16B 1/00

(52) U.S. Cl. 403/348

(57) ABSTRACT

A connector apparatus for conversion between a long handle and a short handle. The connector apparatus includes a tubular body and a connector. The tubular body is formed with an internal shaft hole and at least two projecting walls formed on inner face of the tubular body at equal intervals. Each two adjacent projecting walls define therebetween a passage. The connector has a head section and a stem downward extending from the head section. At least two ribs are annularly disposed on the stem at equal intervals. The top end of each rib has a shoulder face. When assembled, the stem of the connector is fitted into the shaft hole of the tubular body. The ribs are passed through the passages to lower sides of the projecting walls. Then the connector is turned to angularly displace the ribs and make the shoulder faces of the ribs engaged with the bottom faces of the projecting walls. The head section of the connector abuts against top end of the tubular body.

### BACKGROUND OF THE INVENTION

The present invention is related to a connector apparatus which can be assembled and disassembled, and more particularly to a connector apparatus which can be quickly conveniently assembled/disassembled for conversion between a long handle and a short handle.

When using various implements, it is necessary to switch the operation modes thereof to facilitate the use in different environmental conditions. For example, when using cleaning tool to clean a table face, a cleaning tool with short handle is selected for easy and mobile operation. Reversely, when cleaning a floor or a ceiling, a cleaning tool with long handle is preferred for cleaning a remote place.

The conventional connector apparatus are generally assembled/disassembled by means of screwing/unscrewing the connector. This is time-consuming and inconvenient.

### SUMMARY OF THE INVENTION

It is therefore a primary object of the present invention to provide a connector apparatus which can be quickly conveniently assembled/disassembled for conversion between a long handle and a short handle.

The present invention can be best understood through the following description and accompanying drawings wherein:

### BRIEF DESCRIPTION OF THE DRAWINGS

FIG. 1 is a perspective assembled view of a first embodiment of the present invention;

FIG. 2 is a perspective exploded view according to FIG. 2;

FIG. 3 is a longitudinal sectional view of the tubular body of the present invention;

FIG. 4 is a bottom view of the tubular body of the present invention;

FIG. 5 shows the assembly of the present invention;

FIG. 6 is a bottom view according to FIG. 5;

FIG. 7 is a bottom view according to FIG. 6, showing that the assembly of the present invention is completed;

FIG. 8 is a longitudinal sectional view according to FIG. 1;

FIGS. 9 and 10 show the application of the present invention to a cleaning tool;

FIG. 11 is a perspective exploded view of a second embodiment of the present invention;

FIG. 12 is a bottom view of the tubular body according to FIG. 11;

FIG. 13 is a bottom view showing that the connector of FIG. 11 is fitted into the tubular body;

FIG. 14 is a view according to FIG. 13, showing that the assembly is completed;

FIG. 15 is a longitudinal sectional assembled view of the second embodiment of the present invention; and

FIG. 16 is a sectional view taken along line 16-16 of FIG. 15.

### DETAILED DESCRIPTION OF THE PREFERRED EMBODIMENTS

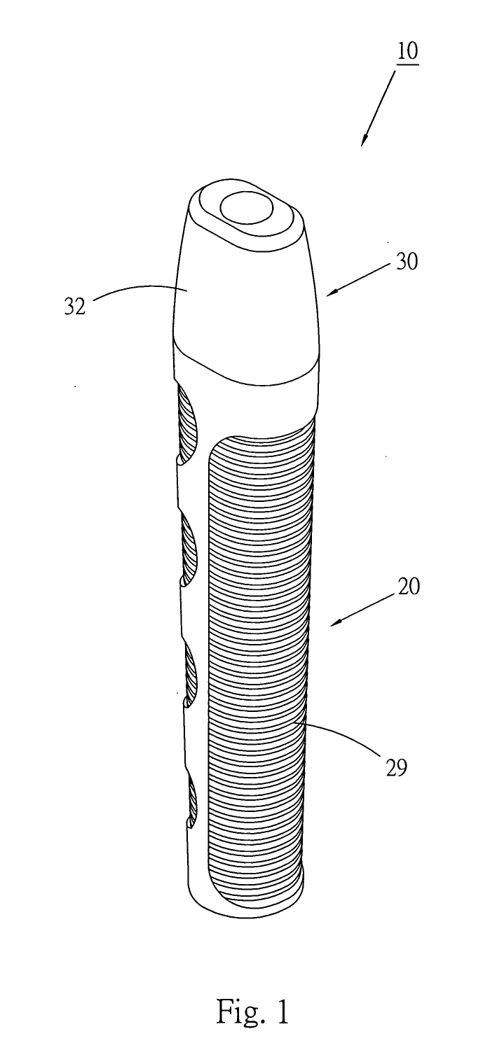

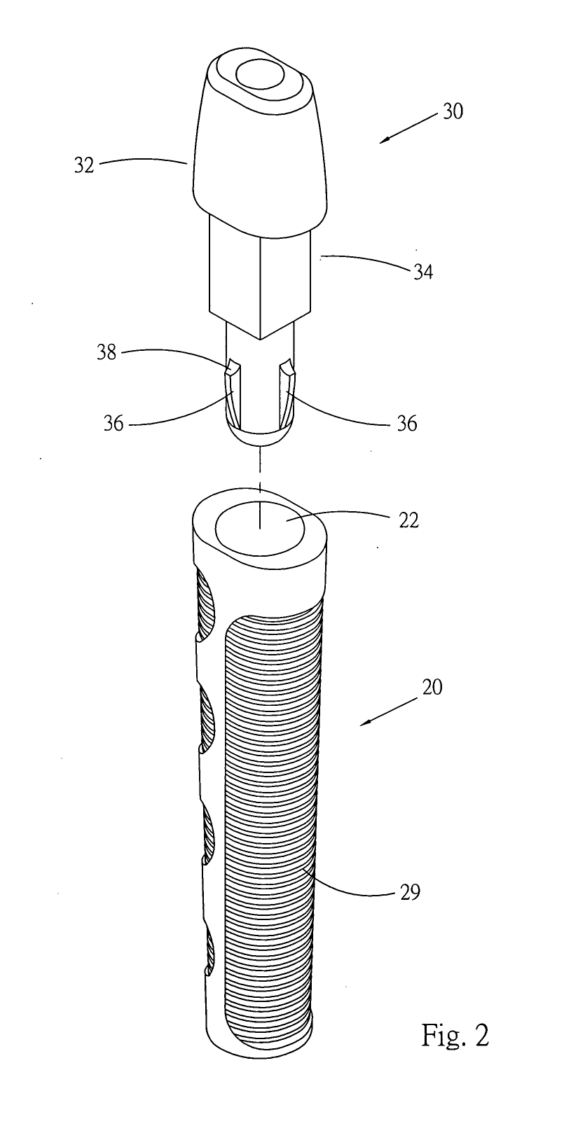

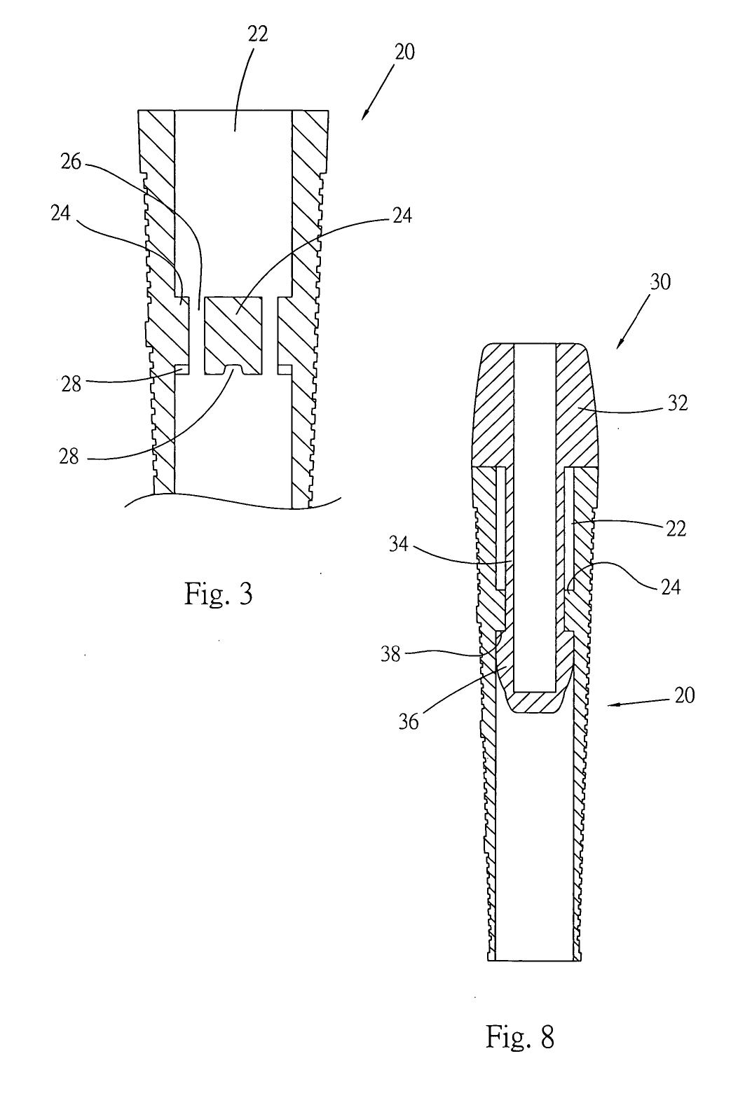

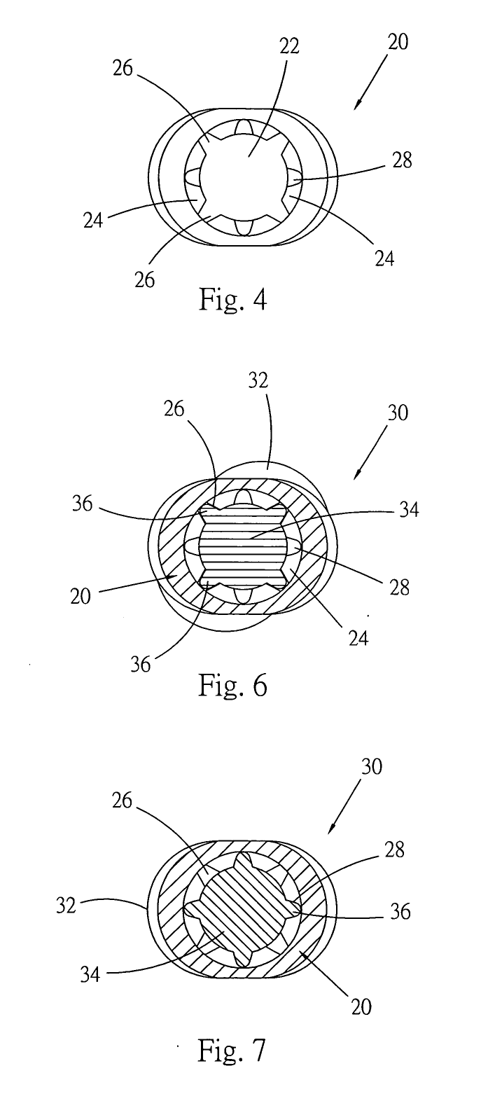

Please refer to FIGS. 1 and 2. According to a first embodiment, the connector apparatus 10 of the present invention includes a tubular body 20 formed with an internal shaft hole 22 passing through the tubular body 20. As shown in FIGS. 3 and 4, four projecting walls 24 are formed on inner face of the tubular body 20 and annularly arranged at equal intervals. Each two adjacent projecting walls 24 define a passage 26. Accordingly, four passages 26 are formed on inner face of the tubular body 20 at equal intervals. The bottom of each projecting wall 24 is formed with a recessed locating section 28. In addition, the four projecting walls 24 define therebetween an inner diameter. The outer circumference of the tubular body 20 is formed with embossed stripes 29 for easy holding.

The present invention further includes a connector 30 having a head section 32 and a stem 34 downward extending from the head section 32. The width of the head section 32 is larger than the diameter of the stem 34. Four ribs 36 are annularly disposed on the circumference of the bottom end of the stem 34 at equal intervals. The ribs 36 outward protrude from the stem 34. The top end of each rib 36 has a shoulder face 38.

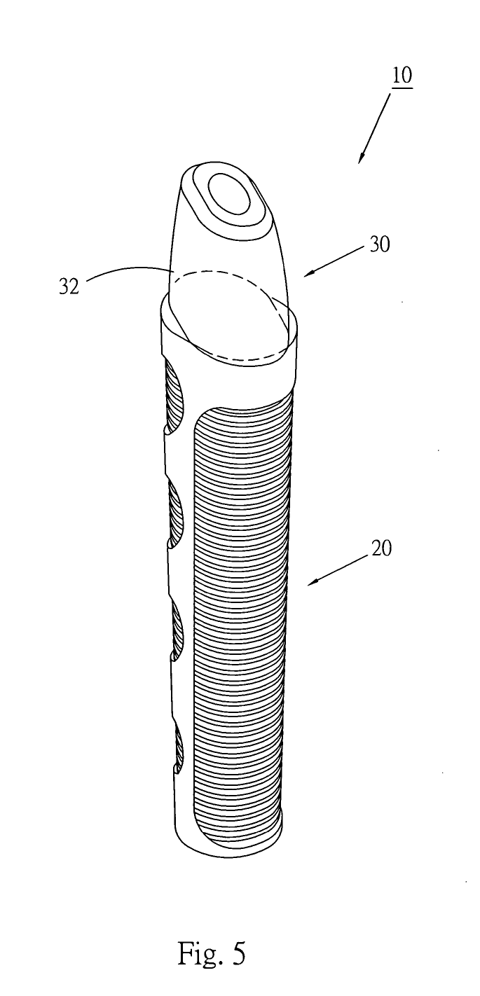

When assembled, as shown in FIGS. 5 and 6, the stem 34 of the connector 30 is fitted into the shaft hole 22 of the tubular body 20. The ribs 36 of the connector 30 are aligned with the passages 26 of the tubular body 20, whereby the ribs can pass through the passages 26 with the stem 34 totally fitted in the shaft hole. Under such circumstance, the head section 32 of the connector 30 abuts against top end of the tubular body 20 with the top ends of the ribs 36 approximately flush with the bottom faces of the projecting walls 24. Then the connector 30 is turned into a state as shown in FIG. 1. At this time, the shoulder faces 38 of the top ends of the ribs 36 are latched in the locating sections 28 of the projecting walls 24 as shown in FIG. 7. Accordingly, the head section 32 of the connector 30 abuts against the top end of the tubular body 20 with the top ends of the ribs 36 abutting against the projecting walls 24 as shown in FIG. 8. Therefore, the head and tail ends of the connector 30 are both engaged with the tubular body 20, whereby the connector 30 cannot be axially pulled to separate from the tubular body 20.

When the connector 30 is turned from the state of FIG. 6 to the state of FIG. 7, the top ends of the ribs 36 are slid over the bottom faces of the projecting walls 24. At this time, the contact faces of the projecting walls 24 and the ribs 36 are tightly fitted with each other. When the ribs reach the locating sections 28 which are recessed, the ribs 36 will be released from the original frictional state of tight fit. An operator's hand can feel the location of the ribs, whereby the operator can judge whether the ribs are located in the locating sections. At this time, the ribs keep stably located in the locating sections 28 without being freely rotated.

When disassembling the connector 30 from the tubular body 20, a user clockwise or counterclockwise turns the connector to change the angular position thereof. At this time, the ribs 36 are restored to the passages 26 back into the state of FIG. 6. Under such circumstance, the connector can be taken out of the tubular body. When the ribs 36 are slid over the bottom faces of the projecting walls 24 to reach the passages 26, the ribs 36 are also released from the frictional state and turned loose. The user can also feel this.

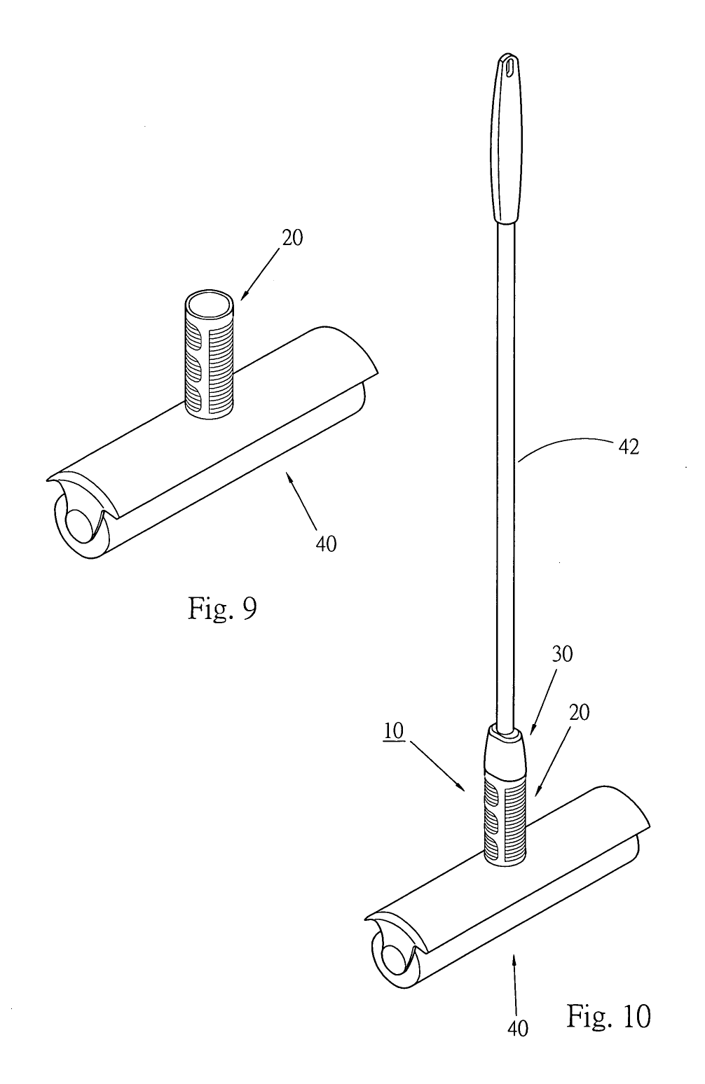

In actual application, the bottom end of the tubular body 20 can be fixedly connected with a cleaning tool 40 as shown in FIG. 9 to form a short handle of the cleaning tool 40 for cleaning a table face, furniture, etc. In addition, as shown in FIG. 10, the top end of the connector 30 can be fixedly connected with an elongated rod 42. The connector is connected with the tubular body 20 to form a cleaning tool with a long handle for cleaning a remote article or space.

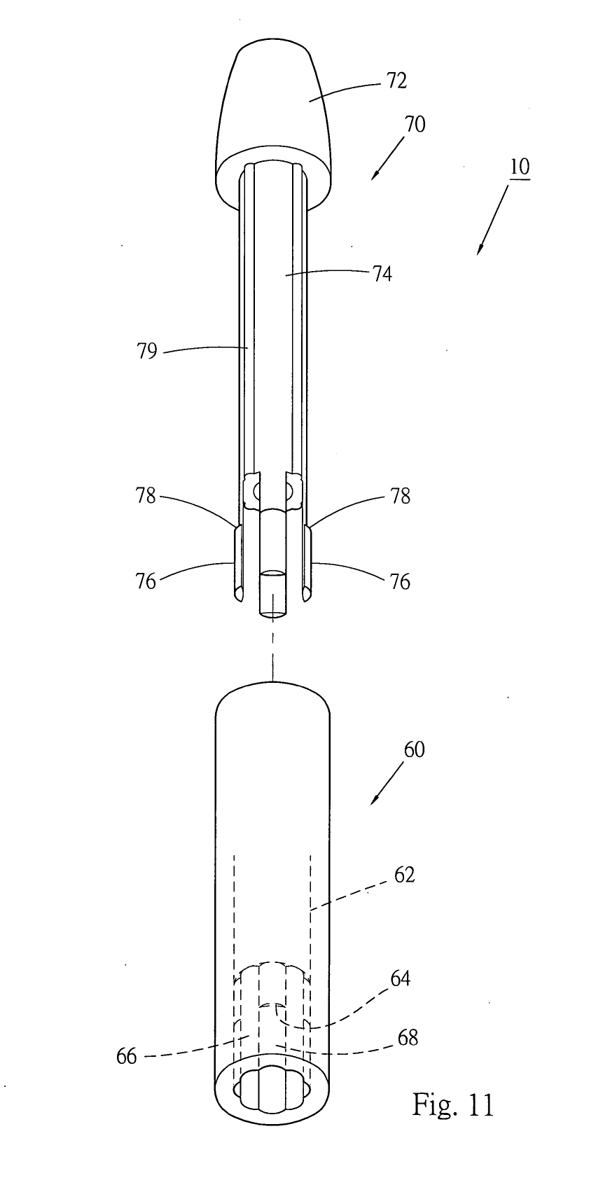

FIG. 11 shows another embodiment of the connector apparatus 50 of the present invention, which also includes a tubular body 60 and a connector 70.

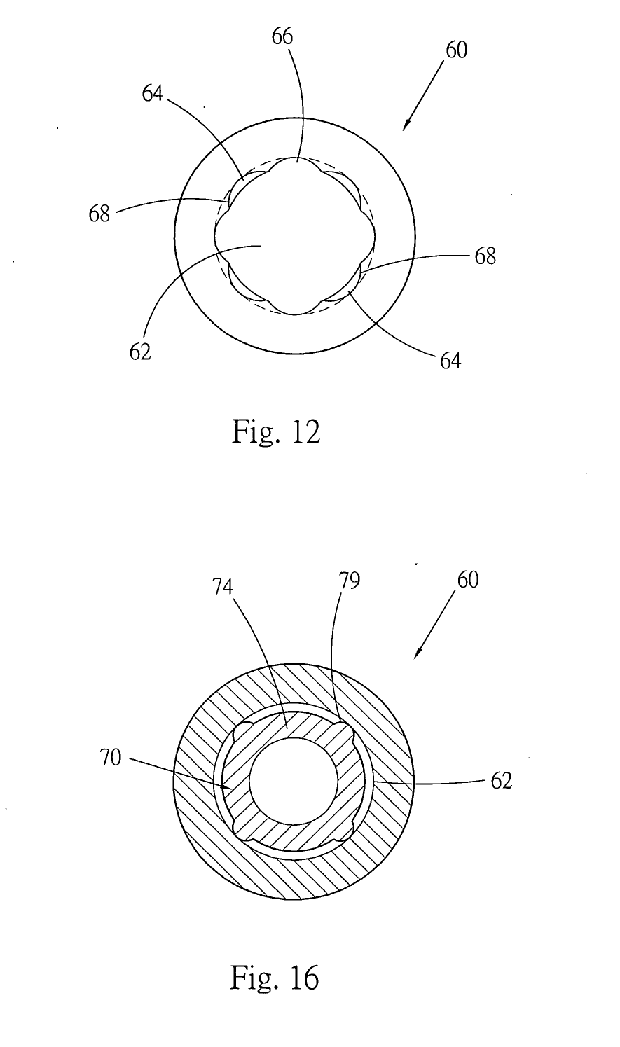

Referring to FIG. 12, the tubular body 60 has a shaft hole 62. Four projecting walls 64 are formed on inner face of the tubular body 60 and annularly arranged at equal intervals. Each two adjacent projecting walls 64 define therebetween a passage 66 for the rib of the connector to freely pass through. Four concave locating sections 68 are formed on inner wall of the tubular body 60 and respectively adjacent to bottom ends of the projecting walls 64. In this embodiment, the passages 66 are also concaves. However, the shape of the passages 66 is not limited.

Four ribs 76 downward extend from the bottom end of the stem 74 of the connector 70. The four ribs are annularly arranged at equal intervals. A shoulder face 78 is formed on outer face of each rib 76 at the top thereof.

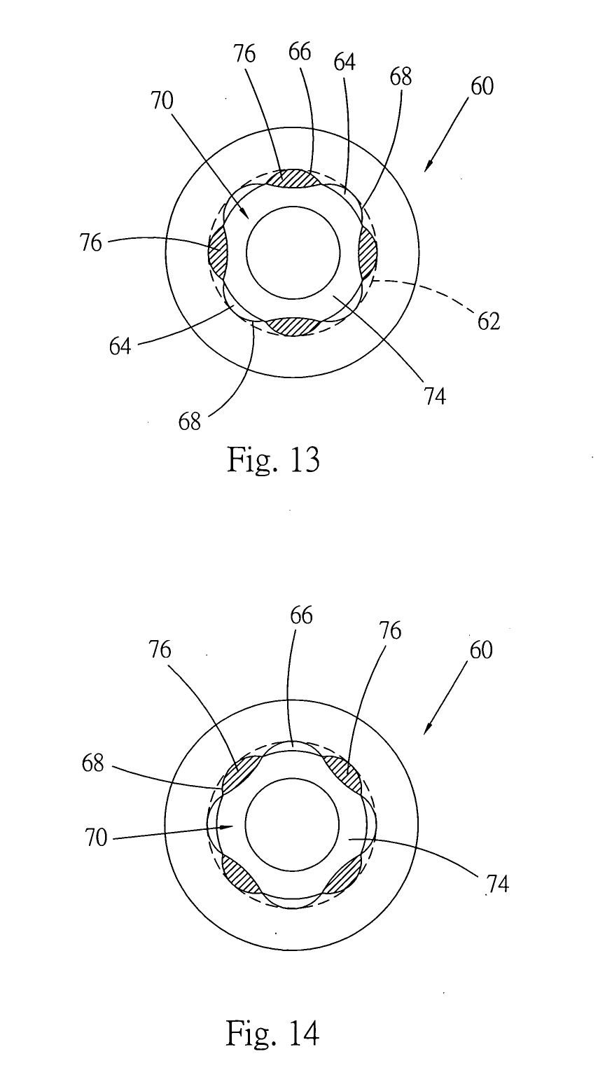

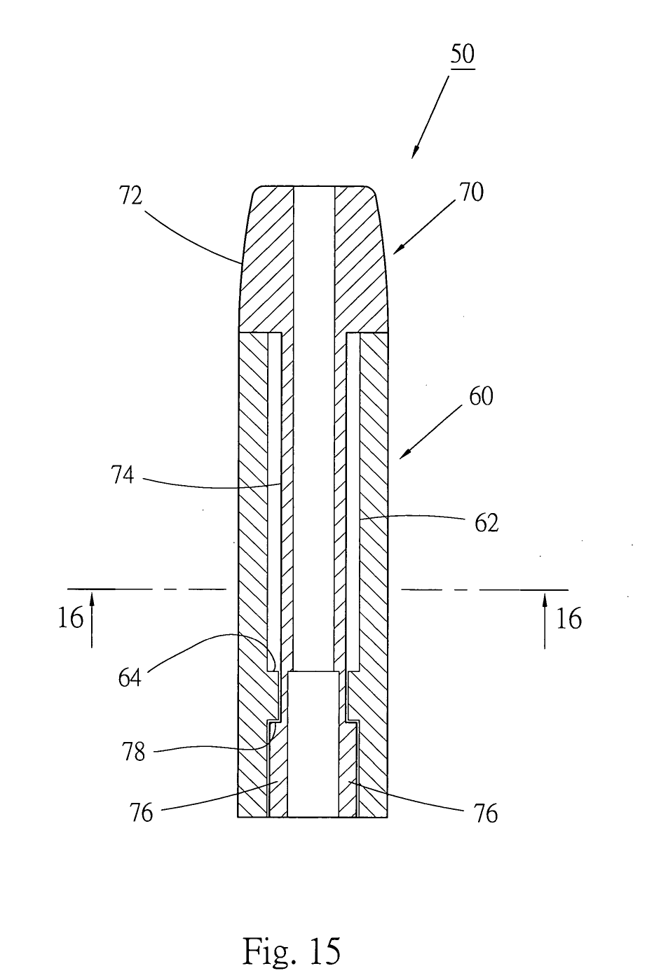

When assembled, as shown in FIG. 13, the stem 74 of the connector 70 is fitted into the shaft hole 62 of the tubular body 60. At this time, the ribs 76 are positioned in the passages 66, whereby the ribs can be freely slid within the tubular body. After the stem is totally fitted into the tubular body, the connector 70 is turned to a state of FIG. 14, whereby the ribs 76 are angularly displaced to move into the locating sections 68. The ribs 76 are suspended so that when the ribs are moved from the passages into the locating sections, the ribs can resiliently swing for a user to feel the location. After the ribs are moved into the locating sections, the shoulder faces 68 of the ribs are engaged with the bottom faces of the projecting walls 64 as shown in FIG. 15. Also, the head section 72 of the connector abuts against the top end of the tubular body.

When disassembled, the connector 70 is turned to the state of FIG. 13 to move the ribs 76 back to the passages 66. At this time, the ribs 76 are disengaged from the projecting walls 64.

The connector apparatus of the present invention provides conversion between long handle and short handle. It is very convenient to assemble/disassemble the connector and the tubular body. In addition, after assembled, the assembly has a firm structure.

The above embodiments are only used to illustrate the present invention, not intended to limit the scope thereof. Many modifications of the above embodiments can be made without departing from the spirit of the present invention.

1. A connector apparatus for conversion between a long handle and a short handle, comprising:
a tubular body formed with an internal shaft hole passing through the tubular body, at least two projecting walls being formed on inner face of the tubular body at equal intervals, each two adjacent projecting walls defining therebetween a passage; and
a connector having a head section and a stem downward extending from the head section, the head section having a width larger than a diameter of the stem, at least two ribs being annularly disposed on the stem at equal intervals, a top end of each rib having a shoulder face, whereby when assembled, the stem of the connector is fitted into the shaft hole of the tubular body, the ribs being passed through the passages to lower sides of the projecting walls, then the connector being turned to angularly displace the ribs and make the shoulder faces of the ribs engaged with the bottom faces of the projecting walls, the head section of the connector abutting against top end of the tubular body.

2. The connector apparatus as claimed in claim 1, wherein the bottom faces of the projecting walls are formed with locating sections, the number of the locating sections being equal to the number of the projecting walls, whereby when the ribs are engaged with the projecting walls, the shoulder faces of the ribs are located in the locating sections.

3. The connector apparatus as claimed in claim 2, wherein the bottom faces of the projecting walls are recessed to form the locating sections.

4. The connector apparatus as claimed in claim 1, wherein locating sections are formed on inner face of the tubular body, the number of the locating sections being equal to the number of the projecting walls, whereby when the ribs are engaged with the projecting walls, the shoulder faces of the ribs are located in the locating sections.

5. The connector apparatus as claimed in claim 4, wherein the inner face of the tubular body is recessed to form the locating sections which are adjacent to the bottom ends of the projecting walls.

6. The connector apparatus as claimed in claim 1, wherein the ribs are disposed on a circumference of the stem.

7. The connector apparatus as claimed in claim 1, wherein the ribs downward axially extend from the bottom end of the stem and are suspended.

8. The connector apparatus as claimed in claim 1, wherein the outermost circumference of the stem of the connector abuts against the inner face of the tubular body.
